(19) United States
(12) Patent Application Publication
(10) Pub. No.: US 2008/0138587 A1
(43) Pub. Date: Jun. 12, 2008

(54) INSERT MOLDING ARTICLE INCLUDING PORTIONS MADE OF DIFFERENT MATERIALS

(75) Inventors: XI-QIU WU, Shenzhen (CN); GENG-HUI GUO, Shenzhen (CN); SHI-JIN LONG, Shenzhen (CN); GUANG-XIANG ZHANG, Shenzhen (CN); HSIAO-HUA TU, Shindian (TW)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRIAL CO.,LTD., Shenzhen (CN); SUTECH TRADING LIMITED, Tortola (VG)

(21) Appl. No.: 11/735,003

(22) Filed: Apr. 13, 2007

(30) Foreign Application Priority Data
Dec. 8, 2006 (CN) 200610157359.5

(51) Int. Cl. B32B 23/02

(52) U.S. Cl. 428/192

(57) ABSTRACT

An insert molding article (20) includes a plastic element (24) and an inserting element (22). The inserting element includes a main portion (222) and an inserting portion (224) formed on and extending from the main portion. The inserting portion is enclosed, encapsulated, and secured in the plastic element. By being molded in such a manner, the plastic element frictionally engages at least two sides of the inserting portion, thereby resulting in a mechanically stable connection between the plastic element and the inserting portion.

### BACKGROUND OF THE INVENTION

1. Field of the Invention

The present invention relates to an insert molding article, and, particularly, to an insert molding article including a plastic element and an inserting element made of other materials.

2. Description of Related Art

Some workpieces include portions respectively made of different materials. Many kinds of these workpieces are fabricated by means of insert molding, i.e., they are insert molding articles. For example, a housing of a portable electronic device includes a plastic element and an inserting element made of another material. When the housing is fabricated, the inserting element is placed in a mold, and melted plastic is injected into the mold. After the melted plastic solidifies, the plastic element is formed on the inserting element, and the housing is completed.

Referring to FIG. 1, a housing 10 of a portable electronic device is made up of a inserting element 12 and a plastic element 14. The inserting element 12 is made of one or more inorganic materials, such as metal, glass, etc, and a melting point of the inserting element 12 is higher than that of the plastic element 14. The inserting element 12 includes a main portion 122 and an inserting portion 124. The main portion 122 is a first board. The inserting portion 124 is a second board formed on a side of the main portion 122, extending approximately perpendicularly therefrom. In production, the inserting element 12 of the housing 10 is placed in a mold, and melted plastic is injected into the mold. After the melted plastic solidifies, the plastic element 14 is thereby formed on the inserting element 12 and attached on/to a side of the inserting portion 124, and the housing 10 is completed.

However, when the melted plastic is injected at a high temperature into the mold and contacts with the inserting element 12, the inserting element 12 may expand and be distorted. Since the inserting portion 124 has only one side attached to the plastic element 14, there is not a necessarily firm contact between the inserting element 12 and the plastic element 14. Therefore, the inserting element 12 is prone to break away from the plastic element 14.

Therefore, a new insert molding article is desired in order to overcome the above-described shortcomings.

### SUMMARY OF THE INVENTION

In a preferred embodiment thereof, an insert molding article includes a plastic element and an inserting element. The inserting element includes a main portion and an inserting portion formed on the main portion. The inserting portion is enclosed and secured in the plastic element.

Other advantages and novel features of the present insert molding article will become more apparent from the following detailed description when taken in conjunction with the accompanying drawings.

### BRIEF DESCRIPTION OF THE DRAWINGS

Many aspects of the present insert molding article can be better understood with reference to the following drawings. The components in the various drawings are not necessarily drawn to scale, the emphasis instead being placed upon clearly illustrating the principles of the present insert molding article. Moreover, in the drawings, like reference numerals designate corresponding parts throughout the figures.

FIG. 1 is a schematic view of a conventional insert molding article;

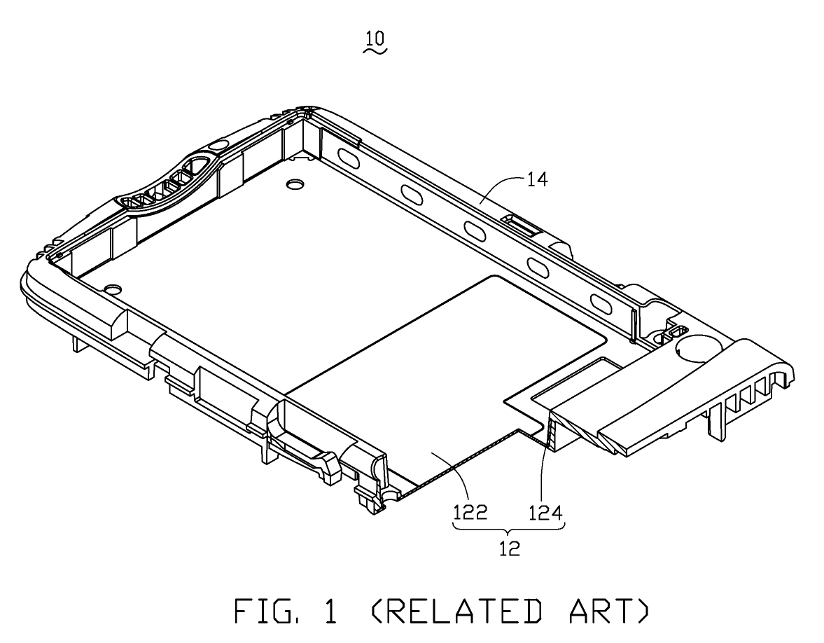

FIG. 2 is a partial cut-away view of an insert molding article, in accordance with a first embodiment;

FIG. 3 is an enlarged view of the area III, shown in FIG. 2;

FIG. 4 is a partial cut-away view of an insert molding in accordance with a second embodiment; and

FIG. 5 is an enlarged view of the area V, shown in FIG. 4.

### DETAILED DESCRIPTION OF THE INVENTION

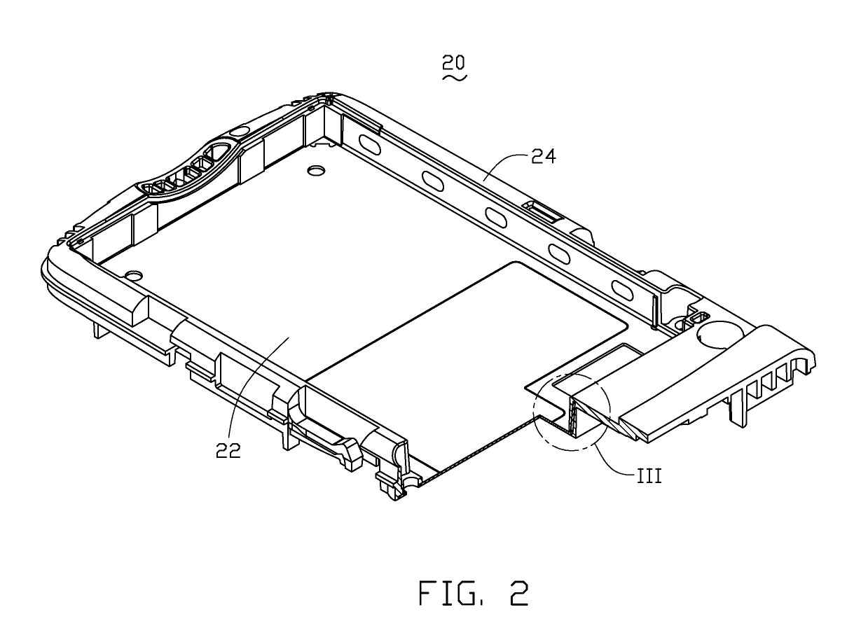

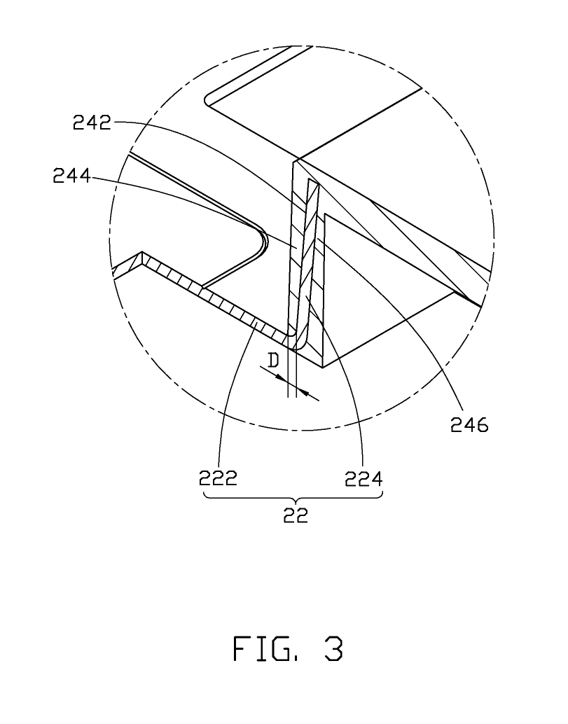

Referring now to the drawings in detail, FIG. 2 and FIG. 3 show an insert molding article 20, in accordance with a first preferred embodiment. The insert molding article 20 is a side-walled planar element that can be used as a part of a housing of a portable electronic device. The insert molding article 20 includes an inserting element 22 and a plastic element 24. The inserting element 22 is made of one or more inorganic materials, such as metal, glass, etc. The melting point of the material(s) used for the inserting element 22 is higher than that of the plastic used for the plastic element 24. The inserting element 22, as shown in FIG. 3, includes a main portion 222 and an inserting portion 224. The main portion 222 is a board (i.e., a planar element). The inserting portion 224 of the inserting element 22 extends directly from a side of the main portion 222 and approximately perpendicularly thereto.

The plastic element 24 is a block defining an inserting aperture/slot/groove 242 therein. A holding portion 244 and a contacting portion 246 are correspondingly formed on two sides of the inserting aperture 242, and the holding portion 244 and the contacting portion 246 are approximately parallel to each other. The inserting aperture 242 corresponds to the inserting portion 224 in dimension and shape, the inserting portion 224 matingly engages the inserting aperture 242 (i.e., an interference/friction fit therebetween), and the holding portion 244 and the contacting portion 246 are respectively attached at least via a friction fit and potentially by a supplemental means (e.g., adhesive and/or mechanical fastener) to opposing surfaces of the inserting portion 224. A thickness D of the holding portion 244 is at least 0.3 millimeter.

When the insert molding article 20 is fabricated, the inserting element 22 is placed in a mold, and melted plastic is injected into the mold. The melted plastic then encloses/envelopes at least two sides of the inserting portion 224 (i.e., the mold thickness exceeding that of the inserting portion 224), with more sides being enveloped thereby if other mold dimensions exceed those (e.g., width, height) of the inserting portion 224. After the melted plastic solidifies, the plastic element 24 is formed in the mold, and the holding portion 244 and the contacting portion 246 are formed on two opposite surfaces of the inserting portion 224, and thus the inserting portion 224 is enclosed, encapsulated, and secured in the plastic element 24. Because at least the holding portion 244 and the contacting portion 246 are frictionally attached to two opposite surfaces of the inserting portion 224, there is a tight contact between the inserting portion 224 of the inserting element 22 and the plastic element 24. In this way, the inserting element 22 is prevented from breaking away from the plastic element 24. As such, the present embodiment represents an improvement, in terms of joint strength and stability, over the prior art version (e.g., housing 10), in which only one side of the inserting portion 124 of the inserting element 12 is contacted by the plastic element 14.

Additionally, the inserting portion 224 could potentially be formed on any part of the inserting element 22. Furthermore, it is to be understood that greater the number of sides of the inserting portion 224 that are enveloped/encapsulated by the plastic element 24, the greater the mechanical stability offered due the frictional contact between such elements 22 and 24. Another potential advantage offered by encapsulation is that the plastic element 24 can act as a barrier to corrosion, if need be.

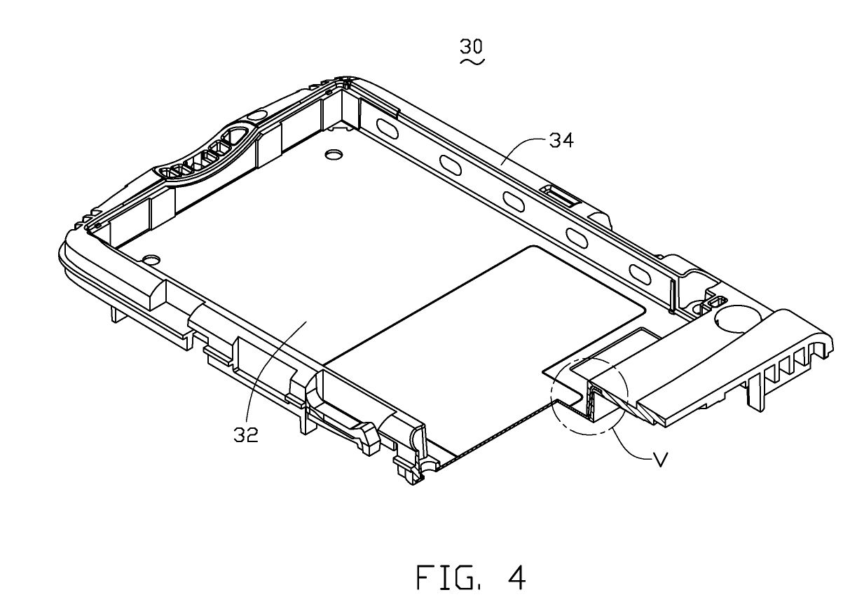

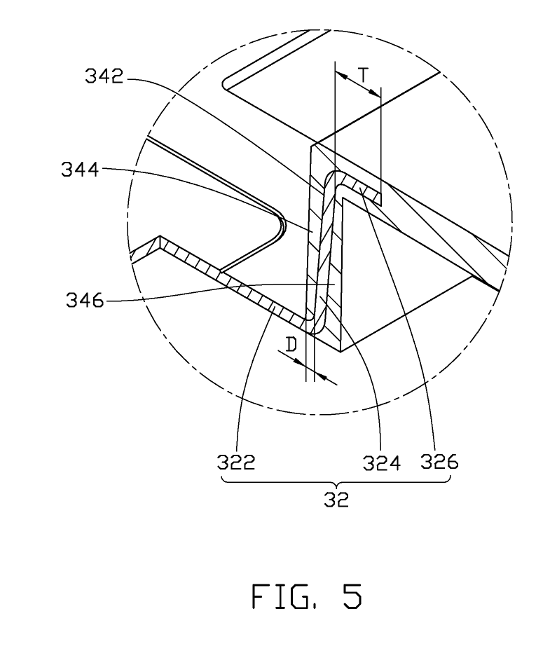

Referring to FIG. 4 and FIG. 5, an insert molding article 30 in accordance with a second preferred embodiment is provided. The insert molding article 30 is a side-walled planar element that can be used to be part of a housing of a portable electronic device. The insert molding article 30 includes an inserting element 32 and a plastic element 34. The inserting element 32 is made of one or more inorganic materials, such as metal, glass, etc, and a melting point of such inorganic materials is higher than that of plastic used for the plastic element 34. The inserting element 32, as shown in FIG. 5, includes a main portion 322, an inserting portion 324, and a clasping/retaining portion 326. The main portion 322 is a board (i.e., a planar section). The inserting portion 324 is extends directly from a side of the main portion 322, approximately perpendicular thereto. The clasping portion 326 is a strip extending directly from the inserting portion 324, usefully from an end thereof distal from the main portion 322, along a direction that is approximately perpendicular to the inserting portion 324 and approximately parallel to the main portion 322. A length T of the clasping portion 326 is at least 1.0 millimeter. It is this clasping portion 326 that is the chief difference between the second embodiment and the first embodiment.

The plastic element 34 is a block defining an inserting aperture/slot/groove 342 therein. At least a holding portion 344 and a contacting portion 346 are correspondingly formed on two sides of the inserting aperture 342, and the holding portion 344 and the contacting portion 346 are approximately parallel to each other. The inserting aperture 342 corresponds to the inserting portion 324 and the clasping portion 326 in dimension and shape. Accordingly, the inserting portion 324 and the clasping portion 326 matingly engage in the inserting aperture 342, with an interference fit therebetween. Thus, the inserting portion 324 and the clasping portion 346 are enclosed in the plastic element 34, and the holding portion 344 and the contacting portion 346 are respectively contactingly/frictionally attached to two opposite surfaces of the inserting portion 324. A thickness F of the holding portion 344 is at least 0.3 millimeter. The presence of the clasping portion 326 essentially eliminates any opportunity of the inserting element 32 slipping out of contact with the plastic element 34. As such, there is not really any need for any supplemental joining (e.g., adhesive and/or mechanical fastener) between the inserting element 32 and the plastic element 34.

When the insert molding article 30 is fabricated, the inserting element 32 is placed in a mold, and melted plastic is injected into the mold, surrounding at least two sides of the inserting element 32, as described above with respect to the first embodiment. The melted plastic then encloses the inserting portion 324 and the clasping portion 326. After the melted plastic solidifies, the plastic element 34 is formed in the mold, and at least the holding portion 344 and the contacting portion 346 are formed on two opposite surfaces of the inserting portion 324, and the inserting portion 324 and the clasping portion 326 are enclosed, encapsulated, and secured in the plastic element 24. Because the holding portion 344 and the contacting portion 346 are attached to two opposite surfaces of the inserting portion 324, there is a tight contact between the inserting portion 324 of the inserting element 32 and the plastic element 34. Furthermore, the clasping portion 326 can clasp/retain the inserting portion 324 in place within in the plastic element 34, effectively acting as an anchor element. In this way, the inserting element 32 is prevented from dislocating from and/or slipping out of the plastic element 34. Essentially, the only way that the inserting element 32 could become dislodged from the plastic element 34 would be for the plastic element 34 to catastrophically fail (e.g., completely break) proximate the inserting element 32.

Additionally, the inserting portion 324 can further be formed on any part of the inserting element 32. While it is advantageous for the clasping portion 326 to extend substantially perpendicular to the inserting portion 324 to maximize the anchor effect thereof, the clasping portion 326 could instead extend along another distinct angle of inclination (e.g., at an oblique angle), relative to the inserting portion 324. By extending at an inclination other than perpendicular, it may be possible to accommodate other design constraints and to yet achieve some degree of the anchor effect attributable to the clasping portion 326.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An insert molding article, comprising:
a plastic element; and
an inserting element including a main portion and an inserting portion formed on the main portion, the inserting portion being enclosed and secured in the plastic element.

2. The insert molding article as claimed in claim 1, wherein the plastic element defines an inserting slot therein, the inserting slot corresponds to the inserting portion in dimension and shape, and the inserting portion matingly engages the inserting slot.

3. The insert molding article as claimed in claim 2, wherein the plastic element includes a holding portion and a contacting portion correspondingly formed on two sides of the inserting slot, the holding portion and the contacting portion being approximately parallel to each other.

4. The insert molding article as claimed in claim 3, wherein the holding portion and the contacting portion are respectively frictionally attached to two opposite surfaces of the inserting portion.

5. The insert molding article as claimed in claim 1, wherein the inserting module includes a clasping portion, the clasping portion being a strip extending from the inserting portion at a distinct angle of inclination relative thereto.

6. The insert molding article as claimed in claim 5, wherein the clasping portion extends along a direction that is approximately perpendicular to the inserting portion.

7. The insert molding article as claimed in claim 5, wherein the clasping portion is enclosed and secured in the plastic element.

8. The inserting module article as claimed in claim 1, wherein the inserting portion is made of at least one inorganic material, and a melting point of the inserting portion is higher than that of the plastic element.

9. An insert molding article, comprising;
a plastic element; and
an inserting element including a main portion and an inserting portion formed on the main portion, the plastic element being attached to at least two opposite surfaces of the inserting portion.

10. The insert molding article as claimed in claim 9, wherein the plastic element defines an inserting groove therein, the inserting groove corresponds to the inserting portion in dimension and shape, and the inserting portion frictionally engages the inserting groove.

11. The insert molding article as claimed in claim 10, wherein the plastic element includes a holding portion and a contacting portion correspondingly formed on two sides of the inserting aperture, and the holding portion and the contacting portion are approximately parallel to each other.

12. The insert molding article as claimed in claim 9, wherein the inserting portion is enclosed and secured in the plastic element.

13. The insert molding article as claimed in claim 9, wherein the inserting module further includes a clasping portion, the clasping portion being a strip extending from the inserting portion at a distinct angle of inclination relative thereto.

14. The insert molding article as claimed in claim 13, wherein the clasping portion extends approximately perpendicular to the inserting portion.

15. The insert molding article as claimed in claim 13, wherein the clasping portion is enclosed and secured in the plastic portion.

16. The inserting module article as claimed in claim 9, wherein the inserting portion is made of inorganic material, and a melting point of the inserting portion is higher than that of the plastic portion.
